(19) United States
(12) Patent Application Publication
(10) Pub. No.: US 2018/0052814 A1
(43) Pub. Date: Feb. 22, 2018

(54) INTEGRATED TOOL FOR WORK INTAKE

(71) Applicants: Moiz Abbasbhai Mundiwala, Weatogue, CT (US); Steinar Ryen, Glastonbury, CT (US)

(72) Inventors: Moiz Abbasbhai Mundiwala, Weatogue, CT (US); Steinar Ryen, Glastonbury, CT (US)

(21) Appl. No.: 15/240,268

(22) Filed: Aug. 18, 2016

(51) Int. Cl. G06F 17/24; G06Q 10/10; G06F 17/30; G06F 3/0484

(52) U.S. Cl. CPC G06F 17/243; G06F 3/04842; G06F 17/3053; G06Q 10/10

(57) ABSTRACT

Embodiments provide a system having a graphical user interface, the system including: a display providing a graphical user interface that provides a form for a request; a processor that receives user input for populating the form; a processor that determines that the request is discretionary; the graphical user interface providing a function for generating and populating a prioritization score using the user input; the graphical user interface providing a function for generating and populating a strategy score using the user input; a processor that transmits the populated form for request approval; a processor that sets a priority for the request using the prioritization score; a processor that determines whether additional department input is required; the graphical user interface providing a function for receiving user input for populating remaining form fields; and a processor that transmits the populated form for execution of the request. Other aspects are described and claimed.

### FIELD

Embodiments as described herein relate generally to the field of graphical user interfaces and document processing.

### BACKGROUND

To effectuate a change in a company or organization many factors have to be taken into consideration. For example, the company may want to know the cost, both monetary and resource, time, necessary approvals, and the like, associated with the change. In order to start the process, a user typically puts forth a request, which may be within a system. The user then must manually select the appropriate users that the request should be directed to. For example, if a request is for a document change, the person who approves such changes may be different than a person who approves process changes. After selecting the appropriate users, the requestor then generally has to follow up with the next person in the approval process.

Additionally, some requests may be provided in one system having a first set of rules, while other requests may need to be provided in a totally separate system having a different set of rules. A problem with these types of systems is when a single request overlaps the different requesting systems. The requestor then has to manually provide the request information in multiple locations, which is tedious and time consuming. Additionally, these multiple requests could result in double allocation of resources which is unnecessary.

These present problems for companies in identifying requests that still need acted upon. Additionally, it may be difficult for a company to determine when duplicate requests are present due to the multiple requesting systems. Further, the requestor may spend large amounts of time tracking the request and making sure that the next approver completes their tasks before the request can be moved to the next step, which can be detrimental for time sensitive requests. Therefore, there is a need for an integrated work intake request tool that allows a company to receive a request and process the request from start to execution with less user intervention.

### BRIEF SUMMARY

In summary, an embodiment provides a system for providing an integrated tool for processing requests for business needs. The system may include a processor that executes a program of instructions to receive, from an input device, user input for populating a form for a request related to a business need. An embodiment may generate and populate a prioritization score using the user input. The prioritization score may be generated based upon a feasibility score that has been generated using at least part of the user input.

In one embodiment, the system may determine that the request is a discretionary request. If the request is discretionary, the prioritization score may also be based upon a benefit score that is generated using at least part of the user input. Additionally, if the request is discretionary, the system may generate a strategy score which may be based upon at least part of the provided user input.

Once the prioritization score and strategy score, if applicable, have been generated, the system may populate the form with the prioritization score and transmit the populate form for request approval. The request approval may be based, at least in part, on the strategy score if generated. Once the request approval has been received, an embodiment may set a priority for the request based upon the prioritization score.

The system may then determine whether additional department input is required. This determination may be based upon user input indicating that additional department input is required. If additional department input is required, the system may transmit the form to the appropriate departments to receive their impact statements. After receiving the additional department input, or if no additional department input is required, the system may receive additional user input to populate any remaining form fields. The system may generate a cost benefit assessment based upon an estimation of resources and costs associated with the request. The populated form may then be transmitted for execution of the request.

Additional embodiments are described, including other methods, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method for providing an integrated tool for processing requests for business needs.

FIG. 2 illustrates an example business need request form.

FIG. 3 illustrates an example business need request form with score generation.

FIG. 4 illustrates an example form for generating a strategy alignment score.

FIG. 5 illustrates an example form for generating a prioritization score.

FIG. 6 illustrates an example engagement document.

FIG. 7 illustrates an example cost and benefit form.

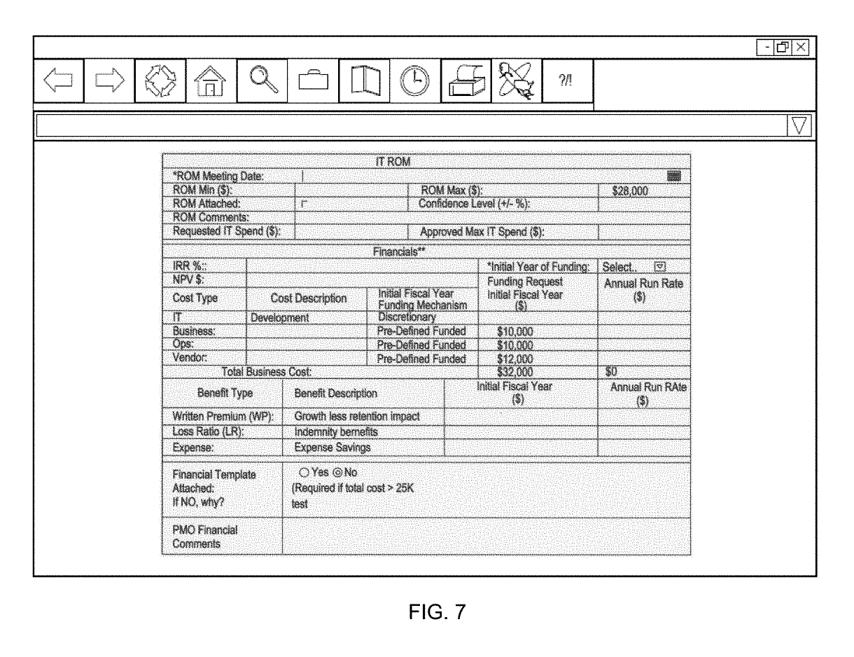

FIG. 8 illustrates an example system for an integrated tool for work intake.

FIG. 9 illustrates an example system for device management able to support multiple distributed networked centers.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment addresses the issues related to processing a request related to a business need. As will become more apparent in the description of example embodiments, the discussed technological improvements offered by the various embodiments are applicable to companies and/or individuals who have or maintain request systems.

Although various example embodiments are described with a focus on insurance company work requests, the principles and technological improvements offered may likewise be applied to various other companies and request systems. Thus, embodiments permit companies or other entities which have or maintain request systems to leverage an automated system for processing a request. Additionally, embodiments permit a company to use a single request system to process different types of requests which may have different rules associated with the requests. The system can use user input to identify the type of request and populate the form with the necessary fields and approval process. Thus, duplicate requests can be identified and reduced because all the requests are present in a single requesting system.

An embodiment utilizes a data driven approach to identify a request type and direct the request to the correct contributors and approvers. Additionally, depending on the request type, the system may generate different scores to be provided to the contributors and approvers. The contributors and approvers may then use these scores to determine whether the request should be acted upon. An embodiment provides a system and method of managing large amounts of data relating to the request, the appropriate approvers for various types of requests, and the status of the request in the approval and request process. An embodiment may receive and process data contained within multiple data sources, including local and non-local data sources, into a usable format which may allow a user and/or company to make determinations relating to requests. The terms user and company may be used interchangeable throughout to increase readability. Once received and processed, an embodiment may provide output, for example, graphical user interfaces, prompts, databases, notifications, and the like, to a display device which may allow a user to process, track, filter, and the like, the data related to a particular request.

An embodiment may receive user input for populating a form for a request related to a business need. For example, an employee of a company may identify that a law change requires that documentation be changed in order to reflect the change in law. The application or program that a user may access to provide the information regarding the change may be stored in a system server, on a web application platform, collaborative exchange environment, or the like. The application may then store the data associated with the request in a local or non-local storage location (e.g., cloud storage, server storage, local machine storage, remote storage, etc.).

In providing the information related to the request, a user may not fill out every field within the form. For example, in filling out the information for the initial request, a user may only be required to provide enough information so that another user can determine whether the request should be approved to continue the request process.

After receiving the user input, an embodiment may generate and populate different scores. For example, in one embodiment, the system may generate and populate a prioritization score which may indicate the priority that should be associated with a request. As an example, a request related to a law change may have a higher priority than a request for a document change due to a typographical error. Once the form has been populated with the generated scores, an embodiment may transmit the form for request approval. Due to the type of request, the system may identify who will approve the form without any additional input from the user. The system may, once the form has been transferred to the approvers queue, provide a notification to the user that they have an action related to the request.

Once the request has been approved, a priority may be set for the request. The priority may be based upon the prioritization score that was previously generated. Additionally, an embodiment may determine whether additional department input is required. For example, a request that affects multiple departments may need input from those departments to determine the impact to the department. If additional department input is required, the request may be forwarded or transferred to the appropriate departments to await their impact statements. Once the impact statements are received, or if additional department input is not required, the requestor may provide additional user input to populate any remaining required fields. Using this input, an embodiment may generate a cost benefit assessment which may be based upon an estimate of resources and cost. The request may then be populated with the financial information and transmitted to the appropriate department or user for execution or governance of the request.

Thus, embodiments represent a significant technical improvement to management of requests. An embodiment is directed to substantially more than merely a computer implementation of a routine or conventional activity previously known in the industry as it significantly advances the technical efficiency, access, and/or accuracy of managing requests and ensures that a company has visibility of the different requests and a user does not have to manually track the request to ensure that the appropriate approvers or contributors have been selected or are aware of the request and any necessary input by implementing a specific new method and system as defined herein.

An embodiment provides a specific advancement in the area of request management by providing technical benefits in data accuracy, data availability, and data integrity and such advances are not merely a longstanding commercial practice. The embodiments provide improvement beyond a mere generic computer implementation as they involve the compilation, processing, reconciliation, and conversion of significant amounts of data in a new beneficial manner as well as the interaction of a variety of specialized systems, networks, and subsystems.

For example, an embodiment facilitates the efficiency of processing requests related to business needs. Additionally, embodiments facilitate a consistent processing of the requests. For example, the generation of prioritization and strategy scores provide that each of the requests will have a score associated with it that is consistent across all requests. These scores also ensure that the requests are aligned with business desires and needs. For example, the strategy score may identify how closely the request aligns with the company's current values or strategy tenets. In other words, using the systems and methods described herein, a company can identify the requests that resources should be allocated to that would best serve the company.

An embodiment additionally offers a further technological advancement by processing and manipulating the data into a format to be displayed to a user. An embodiment then allows a user the flexibility to view the requests that are pending, where in the process the requests are located, sort the requests, identify what information is missing within the request, and the like. Thus, embodiments provide the technology necessary to automate the manipulation of significant amounts of data from a data source to allow a company the ability to identify requests that are necessary to be implemented or would be most useful to the company.

The illustrated example embodiments will be best understood by reference to the figures. The following description is intended only by way of example, and simply illustrates certain example embodiments.

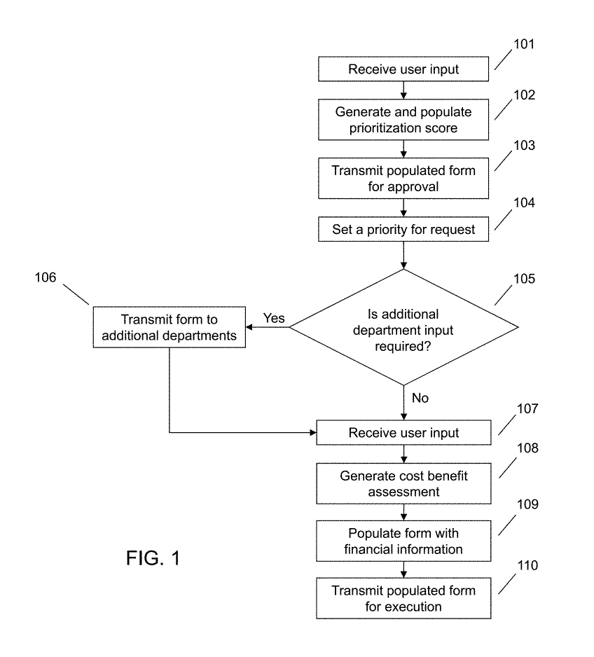

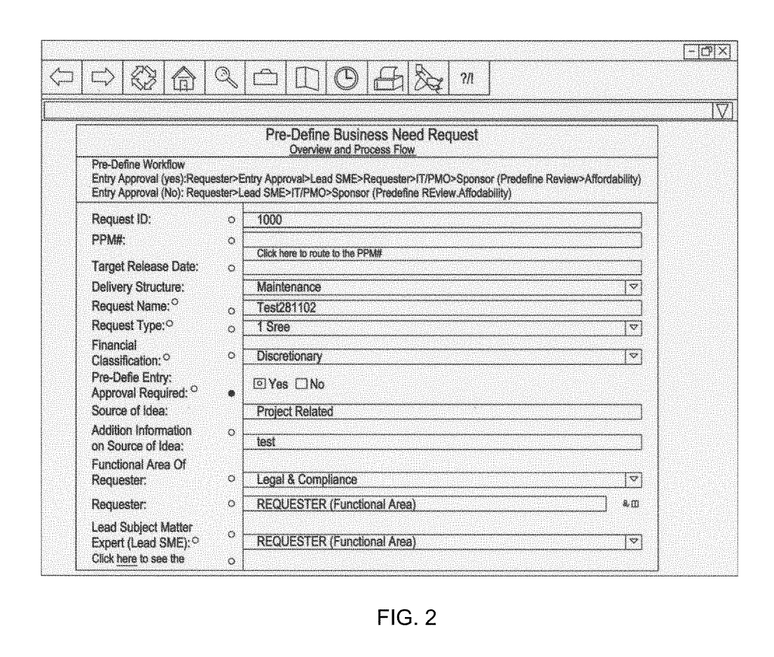

FIG. 1 illustrates an example method for providing an integrated tool for processing requests for business needs. To access the tool, a user may access an application which may be stored on a server, collaborative environment, and the like. For example, a user may access a web application which allows user input. Once the user has access the application, the user may be presented with a form having fillable fields, for example, as shown in FIG. 2. FIG. 2 shows merely a portion of the form and more, less, or differed fields may be included depending on the company needs. Some fields may be required fields while other fields may be optional. The form and/or application may additionally provide the user with instructions or helpful hints in filling out the forms, which may be in the form of descriptions, pop-up windows, and the like.

At 101 an embodiment may receive user input for populating the form that has been displayed on a display device. The user may provide this input through an input device (e.g., keyboard, mouse, touchscreen, etc.). Alternatively or additionally, the input may be imported from another source. For example, the input may be provided in a table format that can then be processed and imported by the tool for use in populating the fields within the form. The input provided by the user may be related to a request related to a business need. For example, a customer of a company may make a request that special provisions be made for the customer. An employee may then make the request through the request form to receive approval to effectuate the change or request.

User input provided at 101 may include information regarding the type of change (e.g., document change, process change, etc.) and a brief description of the change. Additionally, the user input may be used to populate other fields within the form. For example, if a user identifies that the request is related to a law change, the system may identify that such a request is non-discretionary meaning that the change is required. Alternatively, the user can provide input that identifies whether the request is discretionary or non-discretionary. Other types of input are possible, for example, the user may identify the department affected by the request, the customer affected by the request, where the request originated from, the name of the requestor, and the like. This and additional information may be used by the system to identify which people should be populated within the system as approvers or contributors within the request process. The user input provided at this point may not be very detailed. In other words, the user input provided may only be enough to allow an approver to identify whether the request should be approved for entrance into the request process.

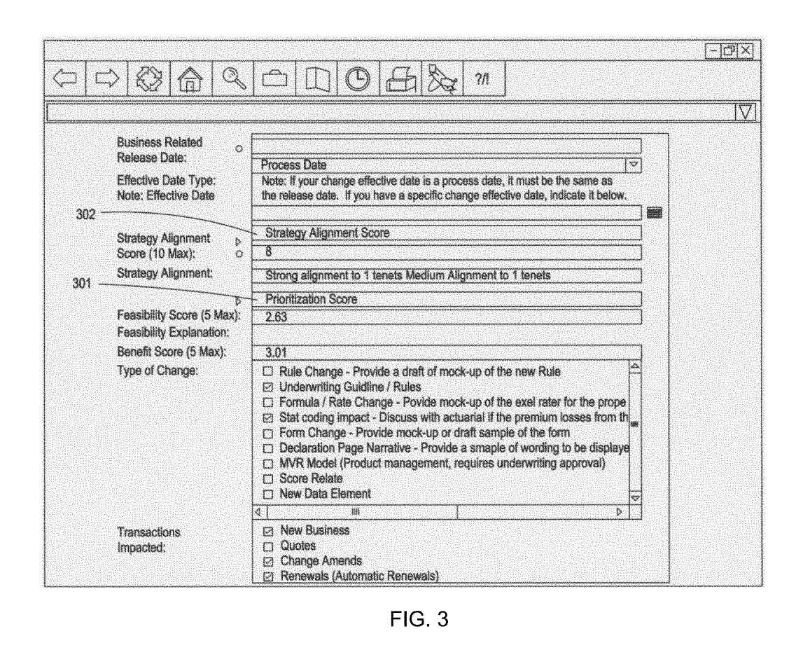

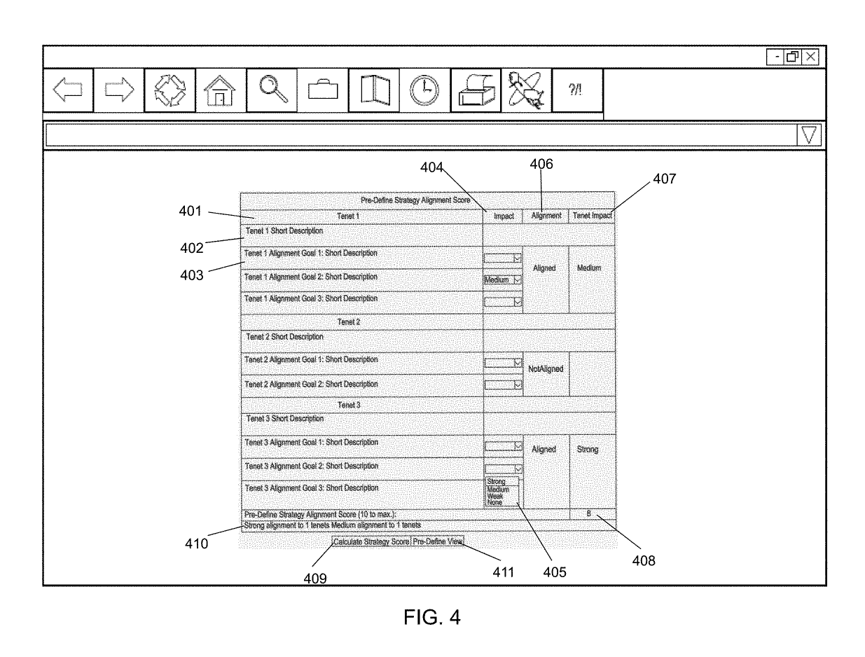

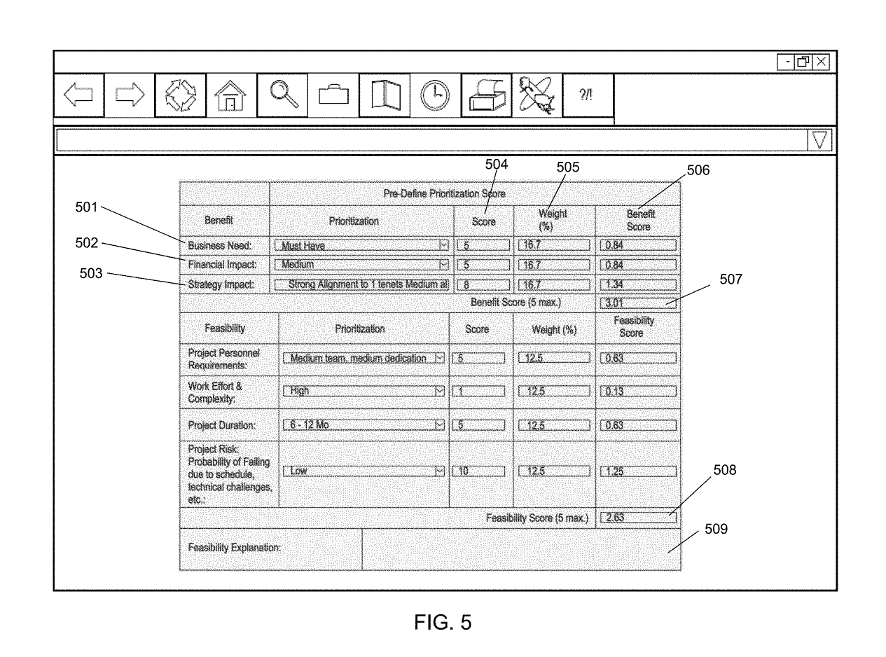

At 102 an embodiment may generate different scores related to the request. To generate the score the user may select a button included on the form, for example, in FIG. 3 at 301 and 302, which may provide a new window for entering information related to the score, for example, as shown in FIGS. 4 and 5, which are described in more detail below.

While shown as a numerical value in FIGS. 3, 4, and 5, the scores may be provided on a scale (e.g., low, medium, high, etc.), numerically (e.g., 1, 2, 3, etc.), on a movable scale, alignment degree, and the like. These scores may be used by approvers, contributors, or the system later in the approval process to make determinations on whether the request should be approved and the effect of the request. In one embodiment the scores generated may be dependent on the type of request. For example, if the request is identified as discretionary, the system may generate more scores to allow approvers to determine whether the request should be entered into the request process. However, if the request is identified as non-discretionary, meaning the request must be processed, the system may not generate as many scores because the request will be entered into the request process regardless of the scores.

If the request has been identified as discretionary, the system may generate a strategy score. The strategy score may identify how aligned the request is to the business values or tenets. Thus, the strategy score may be based upon predetermined strategy rules. In other words, the company may have identified some business tenets that are important to the company. If the request is related to or aligned with one of these tenets the strategy score may reflect this alignment. For example, a request may be able to select the business tenets from a drop down list that the request is associated with. Each tenet may also be weighted, which some tenets having a higher strategy score weighting than others. For example, the company may be very focused on one strategy tenet and may therefore weigh any requests associated with this tenet as having a high strategy score.

Approvers and contributors within the request process may then use this score to determine whether the request should be pursued. In other words, requests that are not aligned with any business strategy may be rejected by approvers within the process. However, just because a request is not aligned with a business strategy or has a low strategy score does not mean that the request will automatically be rejected. Once the applicable scores have been generated, the system may populate the appropriate fields within the form with these scores. To edit or view how the scores were generated, a user can select the button or tab associated with the desired score.

FIG. 4 illustrates an example display for entering information related to the strategy alignment score. The display may provide a tenet 401A, 401B, and 401C, and a short description of the tenet 402A, 402B, and 402C. Under each tenet 401A, 401B, and 401C, may be an alignment goal 403 with a short description explaining the goal. As can be understood, FIG. 4, is merely an example and different display layouts including more or less columns, rows, or information are possible. A user may then provide input on how the alignment goal 403 is impacted by the request. As shown in FIG. 4, the provision of the impact 404 may be in drop-down menu form 405. However, the provision of the impact 404 may be as a fill-in box, on a sliding scale, and the like. Additionally, the impact may be provided in word form (e.g., low, medium, high, etc.), numerically (e.g., 1, 2, 3, etc.), and the like. The user may choose to provide impacts 404 for all alignment goals 403 or for only those goals which are impacted by the request.

Once the impacts 404 are provided, the system may identify whether the request is aligned with the tenet 406. This algorithm may be as simple as identifying whether any of the alignment goals 403 were indicated as being impacted. Alternatively, the algorithm may be based upon a particular threshold. For example, the system may average the impacts 404 and determine whether this average exceeds a particular threshold. The system may also identify the degree of alignment 407 of the request to the tenet. This degree of alignment may simply be the highest impact 404 value. For example, if three alignment goals 403 are impacted and the highest impact 404 value is 5, the degree of alignment 407 may also be 5. Alternatively, the degree of alignment 407 may be based upon an average of the impact 404 values.

After all the impacts 404 have been provided, the system may automatically calculate the strategy alignment score 408. Alternatively, the user may provide input to the system, for example, in the form of a button 409, indicating that the system should calculate the strategy alignment score 408. In calculating the strategy alignment score 408, the system may simply average the degree of alignment 407. However, different algorithms may be used. For example, the system may provide the strategy alignment score 408 based upon the degree of alignment 407 against the number of tenets 401A, 401B, and 401C. As an example, if the request is not aligned to any tenets, the score may be 1. If the request has weak alignment to one tenet, the score may be 2. If the request has weak alignment to two tenets, the score may be 3. If the request has weak alignment to three tenets, the score may be 4. If the request has medium alignment to one tenet, the score may be 5. If the request has medium alignment to two tenets, the score may be 6. If the request has medium alignment to three tenets, the score may be 7. If the request has strong alignment to one tenet, the score may be 8. If the request has strong alignment to two tenets, the score may be 9. If the request has strong alignment to three tenets, the score may be 10. If the request has differing alignment to different tenets, the system may only use the highest alignment. For example, if the request has strong alignment to one tenet and medium alignment to one tenet, the system may ignore the medium alignment and provide a score of 8, due to the strong alignment to one tenet. Other algorithms for calculating the strategy alignment score are possible and contemplated.

Once the score has been calculated, the system may display a description of the score 410. The description may identify how many tenets the request is aligned with and the degree of alignment for each tenet. The system may also provide a button for returning to the request form view 411. Other buttons, descriptions, or selections may be included as necessary.

Another type of score that may be generated by the system is a prioritization score. The prioritization score may identify how critical the request is. For example, a request related to a customer request may be more critical than a request related to an employee request. Thus, the prioritization score can assist in providing a consistent method for identifying priorities of requests so that they can be acted upon in an appropriate queue. The prioritization score may be based upon a feasibility score that is generated by the system using at least part of the user input provided. The feasibility score may be an indication of how difficult or feasible it will be to implement or execute the request if the request is ultimately approved. If the request is a discretionary request, meaning the request does not have to be implemented, the prioritization score may additionally be based upon a benefit score. The benefit score may identify how useful the implemented request may be to the company. For example, a request to change a process to make it more streamlined may be more beneficial that a request to fix a typographical error.

FIG. 5 illustrates an example display for entering and calculating the prioritization score. In calculating the total benefit score 507, a user can provide input on the business need 501 of the request. The business need 501, may be identified as a must have, nice to have, not required, and the like. Each of these selections may have a score 504 associated with them. For example, a “must have” request may be associated with the highest score, while a “not required” request may be associated with the lowest score. The user may also provide a degree of financial impact 502. The degree may be provided in a drop-down menu, fill the box form, sliding scale, and the like. Additionally, as described above with respect to the strategy alignment score, the impacts may be provided in word form, numerical form, on a sliding scale, and the like. Similar to the business need 501, the financial impact 502, may have a score 504 associated with it. The prioritization score may also be based on the strategy alignment score 503 as previously discussed. This form entry may be pre-populated with the value previously calculated.

Each of the benefits (e.g., business need 501, financial impact 502, strategy impact 503, etc.) may have a weight 505 associated with it. This may be predetermined by the system, for example, by assigning each benefit the same weight. The weight may also be modified by the system designer. For example, if the company prefers that the business need have more influence over the benefit score, the weight for the business need may be higher than the weight for the other benefits. Based upon the weight 505 and score 504 for each of the benefits, a benefit score 506 may be calculated for each of the benefits. In one embodiment, the benefit score 506 may be calculated by multiplying the score 504 by the weight 505 for each of the benefits 501, 502, and 503. The calculated benefit scores 506 may then be added together to get the total benefit score 507.

If the prioritization score is also dependent on the feasibility of the request, a feasibility score 508 may be generated in a similar manner to the total benefits score 507. The feasibility score 508 and benefit score 507 may have equal weightings in the overall prioritization score. Therefore, as shown in FIG. 5, the weights associated with each benefit or feasibility may be based upon a percentage of the prioritization score. In other words, the weights for each of the benefits may equal 50% and the weights for each of the feasibilities may equal the other 50%. The form may also provide space for the user to provide comments or additional input 509. For example, the user may provide input describing the expected duration, information used to make the determination of the scores, and the like.

At 103 an embodiment may transmit the populated form for request approval. As stated above, the form may not be fully populated. Rather, the form may only have enough information for an approver or contributor to determine whether the request should be pursued. In transmitting the populated form, the system may identify the appropriate approver to transmit the form to. In other words, the requestor does not have to identify who the approver is. Rather, the approvers may be dependent on the type of request, the business departments affected by the request, and the like. For example, for a discretionary request the approver may be different than a non-discretionary request. In transmitting the form, the system may update with the person having the next action. The form may also be placed in that person's system box. For example, the application may have inbox system associated with it. When a person accesses the system, they can select an icon, tab, or the like, which identifies which requests are currently waiting on them to take an action. The system may additionally notify the person, for example, by sending an email, providing a pop-up window, and the like, that a request needs them to take action.

The request approval may include an approver deciding whether the request is worth pursuing. In making this determination an approver may use the prioritization and strategy score, if applicable, to identify whether the request should be processed and executed. If the approver rejects the request, the requestor may be notified, the request may be removed from the system, and/or the request may be noted with a rejected status. The approver can additionally provide comments on why the request is being rejected. If the approver approves the request, the system may, at 104, set a priority for the request which may be based, at least in part, on the prioritization score. The approver may additionally provide input that may affect the priority setting for the request.

The system may then transmit the approved request to the next contributor using the methods as described above. The next contributor may be identified by the system using the same methods as described above (e.g., based on the request type, the business department affected, etc.). This contributor may identify whether additional departments are affected by the request. In other words, the system may determine, at 105, whether additional department input is required. In making this determination, the system may use the contributor input or may use information provided in the request. For example, if the requestor identified which business departments may be affected, the system may automatically identify that additional department input is required.

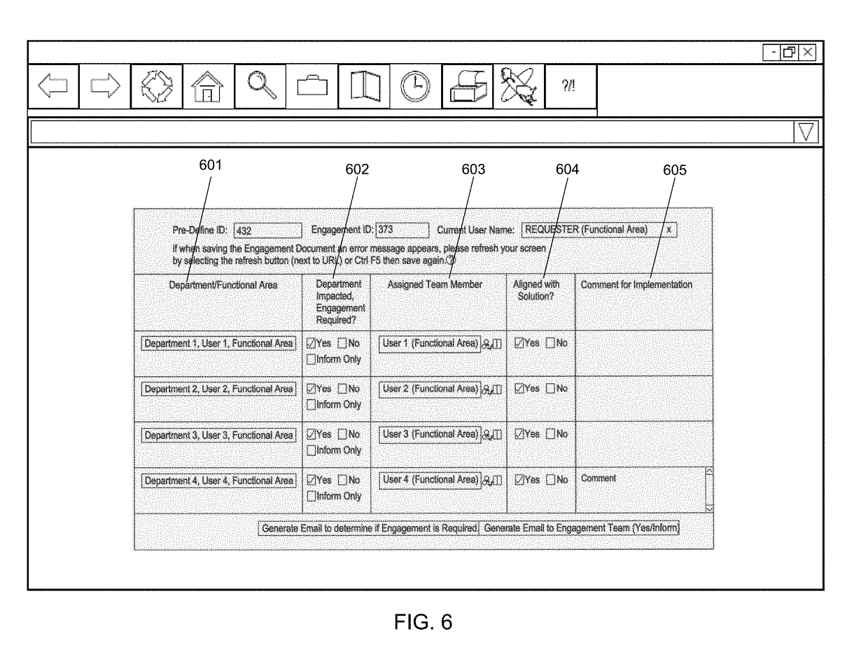

Alternatively, an embodiment may automatically populate a possible department impact form, for example, as shown in FIG. 6. Based upon previously provided input, the system may identify departments which may potentially be impacted and populate the form with these departments 601. The requestor may then identify whether the department is actually impacted, not impacted, or merely needs to be informed of the request 602. The system may automatically populate the user or team member 603 that should be informed of the request. This team member may be identified within the system as the point of contact for any requests impacting a particular department. The requestor may also override the populated team member 603 if a different team member should be notified. Once a user within the impacted department 601 has reviewed the request, the department member can identify whether they understand and are aligned with the request 604. The department member can also provide comments 605 if necessary. For example, the department member may describe additional actions that need to be taken in order to align the department with the request.

If additional department input is required, the system may transmit the form to the additional departments at 106. In transmitting the form to the additional departments, the system may transmit it to an identified person or group. For example, rather than a particular individual, the form may be transmitted to a group inbox, which can be accessed by anyone within the department. As another example, a team may be created to engage the other groups in a discussion about impacts to the department. The system may then await the department or engagement team to provide one or more impact statements. The impact statements may be attached documents, for example, a word processing document, spreadsheet, and the like, or may be input provided directly in the form. As an example, the form may include a box for providing free form input allowing the department to describe the impact to the department. Alternatively, the form may provide radial buttons or drop down menus to identify the impact. As an example, the form may provide a radial button that can be selected to identify no impact to the department. As another example, the form may provide a pull-down menu which ranges of cost impacts.

Once all the additional department input is received, or if no additional department input is required, the system may transmit the form back to the requestor and receive additional user input at 107. This additional input may include the requestor providing any newly required information that has not previously been provided. It may also include the requestor providing more details regarding the request that were not previously provided. Not all form fields may be populated after the requestor has provided all the remaining information. For example, some form fields may not be applicable to every request and, therefore, may not be filled out for every request. Additionally, some forms fields may request information that is unknown to the requestor or may be known at a later date in time. Once the requestor has finished populating the form with the additional input, the system may transmit the form to the next contributor. More, less, or different contributors can be included in the request process.

At 108 an embodiment may generate a cost and benefit assessment. This cost and benefit assessment may be based upon an estimation of resources and cost provided by a user or contributor. For example, a company may require a contributor to prepare a rough order of magnitude (ROM) estimation. This may be prepared or input into the form, for example, as shown in FIG. 4, through the use of a tab or icon. The ROM may include different fields and identify the estimated cost and resources needed to execute the request. At 109 an embodiment may populate the form with financial information which may be based upon the cost benefit assessment. In addition, the system may update the form with the necessary approvers. For example, if the request will cost a particular amount of money, the approver may be different than if the request costs a different amount of money. In other words, the system may be set up that the more a request costs, the more approvers are necessary or that the approvers that are necessary need to have a higher approval authority. Once the financials are updated the system may transmit the form to the next contributor, for example, for final disposition or comment, or move the request for execution at 110. The execution of the request may include receiving business approval for the request.

At any point during the request process, the request may be included in a view which allows a user to view the progress of the request. For example, the application may include a home screen which may allow a user to sort or filter the requests to identify the status of the request. The user may then be able to sort or filter the requests to identify which requests needs to be acted upon, which requests have been approved, and the like.

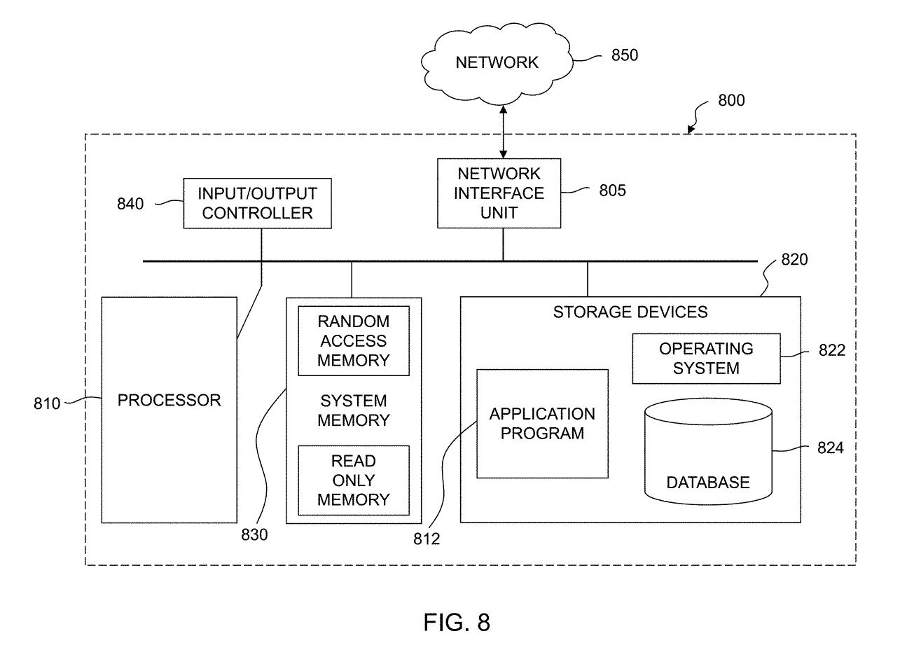

In the example of FIG. 8, a storage device 820 includes software such as a device manager application program 812 that may be run or executed by processor(s) 810 according to an operating system 822. The circuitry 800 provides that the processor 810 loads the operating system 822 and thereafter the application program 812, e.g., into memory 830.

System 800 typically includes a network interface 805 facilitating communications with other devices, e.g., a connection to other devices over a network 850 using components such as a WWAN transceiver, a WLAN transceiver or a wired connection, e.g., a LAN connection. Commonly, system 800 will include an input/output controller 840 for data input and display. System 800 typically includes various memory 830 and storage devices 820, for example a database 824, e.g., for storing data from internal and external data sources, referred to herein.

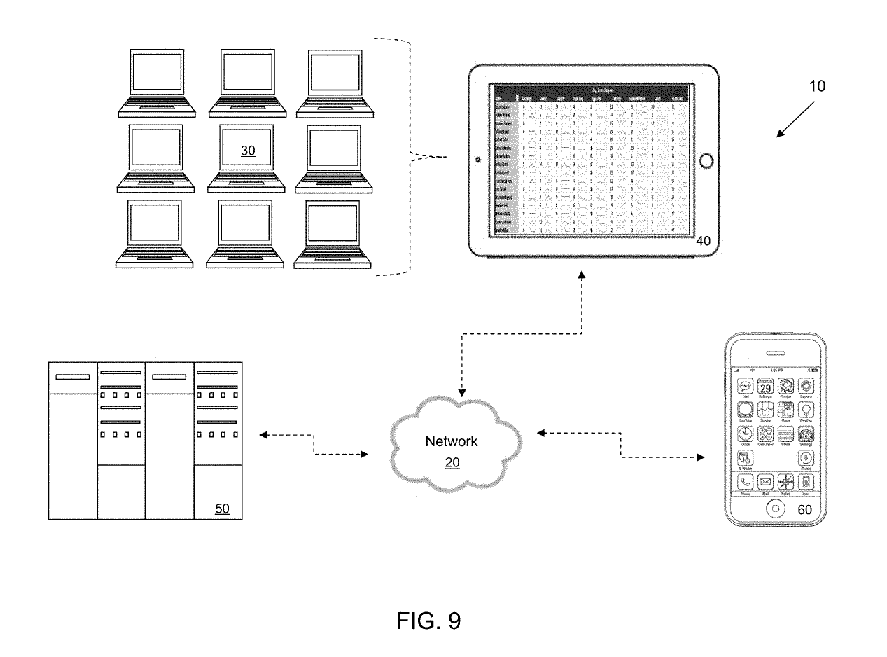

Referring to FIG. 9, there is shown a system 10 for device management that is able to support multiple distributed networked centers in accordance with a preferred embodiment of the present invention. The system 10 is preferably comprised of a communication network 20, a call center 30, a management terminal 40, servers 50, and mobile device 60. Terminal 40 is operable to track and manage call center 30 and provide communications to and from servers 50 and device 60.

Device circuitry, as for example outlined in FIG. 8 and FIG. 9, may be used to generate, manage, and process requests for business needs as described herein. It will also be apparent that circuitry other than the non-limiting example outlined in FIG. 8 and FIG. 9 may be used.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system having a graphical user interface for providing an integrated tool for processing requests for business needs, the system comprising:
a display providing a graphical user interface that provides a form for a request related to a business need;
a processor that receives, from an input device, user input for populating the form;
a processor that determines, based on the user input, that the request is discretionary;
the graphical user interface providing a function for generating and populating a prioritization score using the user input, wherein the prioritization score is generated based upon a feasibility score and a benefit score, wherein the benefit score is generated due to the request being discretionary;
the graphical user interface providing a function for generating and populating, due to the request being discretionary, a strategy score using the user input, wherein the strategy score is based upon predetermined strategy rules;
a processor that transmits the populated form for request approval, wherein the request approval is based at least in part upon the strategy score;
a processor that, upon receiving request approval, sets a priority for the request using the prioritization score;
a processor that determines whether additional department input is required;
the graphical user interface providing a function for receiving user input for populating remaining form fields;
the graphical user interface providing a function for generating a cost benefit assessment, wherein the cost benefit assessment is based upon an estimation of resources and cost;
a processor that populates the form with financial information, wherein the financial information is based upon the cost benefit assessment; and
a processor that transmits the populated form for execution of the request.

2. The system of claim 1, wherein the determining comprises receiving user input indicating additional department input is required.

3. The system of claim 1, further comprising a processor that, if additional department input is required, transmits the populated form to at least one identified additional department and receives impact statements of the at least one identified additional department.

4. The system of claim 1, wherein determining whether additional department input is required comprises the graphical user interface providing a function identifying additional departments potentially impacted based upon the user input.

5. The system of claim 1, wherein a processor generates a notification to a user when user input is required.

6. A system for providing an integrated tool for processing requests for business needs, the system comprising:
a display device;
an input device;
a processor operatively coupled to the display device and the input device;
a memory, with the memory storing instructions executable by the processor to:
receive, from the input device, user input for populating a form, provided on the display device, for a request related to a business need;
generate and populate a prioritization score using the user input, wherein the prioritization score is generated based upon a feasibility score, wherein the feasibility score is generated using the user input;
transmit the populated form for request approval;
upon receiving request approval, set a priority for the request using the prioritization score;
determine whether additional department input is required;
receive user input for populating remaining form fields;
generate a cost benefit assessment, wherein the cost benefit assessment is based upon an estimation of resources and cost;
populate the form with financial information, wherein the financial information is based upon the cost benefit assessment; and
transmit the populated form for execution of the request.

7. The system of claim 6, further comprising instructions executable by the processor to determine, based upon the user input, if the request is discretionary.

8. The system of claim 7, further comprising instructions executable by the processor to, if the request is discretionary, generate and populate a strategy score using the user input, wherein the strategy score is based upon predetermined strategy rules.

9. The system of claim 8, wherein the request approval is based upon the strategy score.

10. The system of claim 7, wherein to generate the prioritization score is further generated, if the request is discretionary, based upon a benefit score, wherein the benefit score is generated using the user input.

11. The system of claim 6, wherein to determine comprises receiving user input indicating additional department input is required.

12. The system of claim 6, wherein determining whether additional department input is required comprises providing a function identifying additional departments potentially impacted based upon the user input.

13. The system of claim 6, further comprising instructions executable by the processor to, if additional department input is required, transmit the populated form to at least one identified additional department and receive impact statements of the at least one identified additional department.

14. The system of claim 6, further comprising instructions executable by the processor to generate a notification to a user when user input is required.

15. The system of claim 6, wherein execution of the request comprises receiving business approval of the request.

16. A system for providing an integrated tool for processing requests for business needs, the system comprising:
a display device;
an input device;
a processor operatively coupled to the display device and the input device;
a memory, with the memory storing instructions executable by the processor to:
receive, from the input device, user input for populating a form, provided on the display device, for a request related to a business need;
determine, based upon the user input, that the request is discretionary;
generate and populate a prioritization score using the user input, wherein the prioritization score is generated based upon a feasibility score and a benefit score, wherein the feasibility score and benefit score are generated using the user input and wherein the benefit score is generated due to the request being discretionary;
generate and populate, due to the request being discretionary, a strategy score using the user input, wherein the strategy score is based upon predetermined strategy rules
transmit the populated form for request approval, wherein the request approval is based upon the strategy score;
upon receiving request approval, set a priority for the request using the prioritization score;
determine whether additional department input is required;
receive user input for populating remaining form fields;
generate a cost benefit assessment, wherein the cost benefit assessment is based upon an estimation of resources and cost;
populate the form with financial information, wherein the financial information is based upon the cost benefit assessment; and
transmit the populated form for execution of the request.

17. The system of claim 16, wherein to determine whether additional department input is required comprises receiving user input indicating additional department input is required.

18. The system of claim 16, wherein to determine whether additional department input is required comprises providing a function identifying additional departments potentially impacted based upon the user input.

19. The system of claim 16, further comprising instructions executable by the processor to, if additional department input is required, transmit the populated form to at least one identified additional department and receive impact statements of the at least one identified additional department.

20. The system of claim 16, further comprising instructions executable by the processor to generate a notification to a user when user input is required.
